(19) United States
(12) Patent Application Publication
(10) Pub. No.: US 2017/0202154 A1
(43) Pub. Date: Jul. 20, 2017

(54) PLANT CULTIVATION METHOD AND PLANT CULTIVATION DEVICE

(71) Applicant: TOYOTA BOSHOKU KABUSHIKI KAISHA, Aichi (JP)

(72) Inventor: Yuko YAMAMOTO, Aichi (JP)

(73) Assignee: TOYOTA BOSHOKU KABUSHIKI KAISHA, Aichi (JP)

(21) Appl. No.: 15/326,168

(22) PCT Filed: Aug. 27, 2015
(86) PCT No.: PCT/JP2015/074306

§ 371 Date: Jan. 13, 2017

(30) Foreign Application Priority Data
Sep. 9, 2014 (JP) 2014-183635

(51) Int. Cl. A01G 7/00; A01G 7/04; A01G 31/00

(52) U.S. Cl. CPC A01G 7/00; A01G 31/00; A01G 7/045

(57) ABSTRACT

A plant cultivation method is provided and includes grasping tide-generating force (e.g., relative gravity acceleration), and controlling plant growth conditions (e.g., lighting condition) according to the variation in the tide-generating force. A plant cultivation device is provided and has a growing space for cultivating a plant and includes a grasper for grasping a tide-generating force, and a growth conditions controller for controlling a plant growth conditions in the growing space according to the variation in the tide-generating force.

### TECHNICAL FIELD

The present invention relates to a plant cultivation method and a plant cultivation device.

### BACKGROUND ART

Conventionally, methods for promoting plant growth by controlling the growth conditions such as lighting and temperature have been studied. Specifically, there has been known a method for promoting plant growth by controlling the cultivating light according to the algorithm based on the circadian rhythm specific to the plant (see Patent Document 1). Furthermore, there has been known a plant growth promoting method by making the growing environment hypergravity state (see Patent Document 2).

### PRIOR TECHNICAL LITERATURE

### Patent Literature

[Patent Document 1] JP-A 2012-179009

[Patent Document 2] JP-A 2007-330219

### SUMMARY OF THE INVENTION

### Problems that the Invention is to Solve

However, the plant cultivation method described in the Patent Document 1 requires the analysis for determining the internal cycle specific to each plant variety for preparing the algorithm based on the circadian rhythm. Along with this, the amount of expression of internal clock gene specific to all the plant varieties to be cultivated, and the time-dependent measurement of absorption of carbon dioxide need to be carried out. Therefore, special measuring apparatuses are necessary, and further the time for collecting data for each cultivation variety is required, so that there is a problem in terms of productivity.

In addition, the cultivation method described in the Patent Document 2 requires a special facility for making the cultivation environment hypergravity state, and limits a cultivation space, so that there is a problem in terms of productivity.

The present invention was conceived in view of the above situation. An object of the present invention is to provide a plant cultivation method and a plant cultivation device that can change a plant metabolism by controlling the plant growth conditions according to the variation of the tide-generating force. In particular, an object of the present invention is to provide a plant cultivation method and a plant cultivation device that allows the promotion of plant growth, reduction of cultivation period, increase of biomass, and improvement of components by using relative gravity acceleration which can be readily grasped without special facilities.

### Means to Solve the Problems

The present inventor conducted intensive studies, found that a temporal change in tide-generating force indicated using, as an index, a relative value of gravity acceleration (relative gravity acceleration) based on the standard gravity acceleration as a reference unexpectedly related with metabolism in plant growth and others, and that the control of the plant growth conditions according to the variation in tide-generating force allows the promotion of plant growth, increase of biomass, and improvement of components, and finally achieved the present invention.

The invention of claim 1 is a plant cultivation method and is characterized by including a step of grasping tide-generating force and a step of controlling plant growth conditions according to the variation in the tide-generating force.

The invention of claim 2 is characterized in that the plant growth conditions include lighting condition in the claim 1.

The invention of claim 3 is characterized in that relative gravity acceleration is used as an index of the tide-generating force in the claim 1 or 2.

The invention of claim 4 is characterized in that a plant is grown under dark condition in a time period when the relative gravity acceleration changes from plus to minus based on the standard gravity acceleration as a reference in the claim 3.

The invention of claim 5 is characterized in that a plant is grown under dark condition in a time period when the relative gravity acceleration changes from minus to plus based on the standard gravity acceleration as a reference in the claim 3.

The invention of claim 6 is a plant cultivation device having a growing space for cultivating a plant and is characterized by including a means of grasping a tide-generating force, and a growth conditions controlling means for controlling a plant growth conditions in the growing space according to the variation in the tide-generating force.

The invention of claim 7 is characterized in that the plant growth conditions include lighting condition in the claim 6.

The invention of claim 8 is characterized in that the tide-generating force grasping means includes a means of calculating relative gravity acceleration, and that the growth conditions controlling means includes a means of controlling a plant growth conditions in the growing space according to the calculated relative gravity acceleration in the claim 6 or 7.

The invention of claim 9 is characterized in that a plant is grown under dark condition in a time period when the relative gravity acceleration changes from plus to minus based on the standard gravity acceleration as a reference in the claim 8.

The invention of claim 10 is characterized in that a plant is grown under dark condition in a time period when the relative gravity acceleration changes from minus to plus based on the standard gravity acceleration as a reference in the claim 8.

### Effect of the Invention

According to the plant cultivation method of the present invention, the plant growth conditions can be controlled according to the variation in tide-generating force and the plant metabolism can be changed. In particular, the plant growth can be promoted, the cultivation period can be reduced, the biomass can be increased, and the components can be improved.

In the case where the plant growth conditions including lighting condition, the plant metabolism can be efficiently changed. In particular, the plant growth can be promoted, the cultivation period can be reduced, the biomass can be increased, and the components in the plant can be improved.

In the case where the relative gravity acceleration is used as an index of the tide-generating force, the tide-generating force can be easily grasped eliminating the necessity for special facilities and the plant metabolism can be efficiently changed.

In the case where the plant is grown under dark condition in a time period when the relative gravity acceleration changes from plus to minus based on the standard gravity acceleration as a reference, enhancement of the plant growth rate by the change of the relative gravity acceleration and the dark period when the capacity of using the energy saved by photosynthesis increases are overlapped to promote efficiently the plant growth and reduce the cultivation period can be reduced. Furthermore, the biomass can be increased, and the components can be improved.

In the case where the plant is grown under dark condition in a time period when the relative gravity acceleration changes from minus to plus based on the standard gravity acceleration as a reference, the plant metabolism can be efficiently changed. In particular, the component in the plant can be improved.

Since the plant cultivation device having a growing space for cultivating a plant, a means of grasping a tide-generating force, and a growth conditions controlling means for controlling a plant growth conditions in the growing space according to the variation in the tide-generating force in the plant cultivation device of the present invention, the plant metabolism can be changed. In particular, the plant growth can be promoted, the cultivation period can be reduced, the biomass can be increased, and the components can be improved.

In the case where the plant growth conditions including lighting condition, the plant metabolism can be efficiently changed. In particular, the plant growth can be promoted, the cultivation period can be sufficiently reduced, the biomass can be increased, and the components can be improved.

In the case where the tide-generating force grasping means includes a means of calculating relative gravity acceleration, and the growth conditions controlling means includes a means of controlling a plant growth conditions in the growing space according to the calculated relative gravity acceleration, the tide-generating force can be easily grasped eliminating the necessity for special facilities and the plant metabolism can be efficiently changed.

In the case where the plant is grown under dark condition in a time period when the relative gravity acceleration changes from plus to minus based on the standard gravity acceleration as a reference, enhancement of the plant growth rate by the change of the relative gravity acceleration and the dark period when the capacity of using the energy saved by photosynthesis increases are overlapped to promote efficiently the plant growth and reduce the cultivation period can be reduced. Furthermore, the biomass can be increased, and the components in the plant can be improved.

In the case where the plant is grown under dark condition in a time period when the relative gravity acceleration changes from minus to plus based on the standard gravity acceleration as a reference, the plant metabolism can be efficiently changed. In particular, the component in the plant can be improved.

### BRIEF DESCRIPTION OF THE DRAWINGS

FIG. 1 is a block diagram showing a hardware configuration of a plant cultivation device;

FIG. 2 is a flow chart illustrating a processing routine for controlling plant growth conditions;

FIG. 3 is a graph showing a relationship between a fluctuation of a stem growth rate and a fluctuation of relative gravity acceleration;

FIG. 4 is a graph showing a relationship between relative gravity acceleration and a fluctuation of a stem growth rate under light-dark conditions;

FIG. 5 is a graph showing a fluctuation of relative gravity acceleration (unit; μGal) in an asynchronous cultivation experiment;

FIG. 6 is a graph showing a fluctuation of relative gravity acceleration (unit; μGal) in a synchronous cultivation experiment;

FIG. 7 shows images for comparing a radish grown by asynchronous cultivation (left) with a radish grown by synchronous cultivation (right);

FIG. 8 shows images for comparing a mini qing-geng-cai grown by asynchronous cultivation (left) with a mini qing-geng-cai grown by synchronous cultivation (right);

FIG. 9 is a graph showing a fluctuation of relative gravity acceleration (unit; μGal) in a dark period synchronous cultivation experiment;

FIG. 10 shows appearance images of qing-geng-cai of Experimental Examples 9-A-1 to 9-A-20 grown in the test section A;

FIG. 11 shows appearance images of qing-geng-cai of Experimental Examples 9-B-1 to 9-B-20 grown in the test section B;

FIG. 12 shows appearance images of leaves of qing-geng-cai of Experimental Example 9 grown in the test section A;

FIG. 13 shows appearance images of leaves of qing-geng-cai of Experimental Example 9 grown in the test section B;

FIG. 14 shows appearance images of radish of Experimental Examples 10-A-1 to 10-A-9 grown in the test section A; and

FIG. 15 shows appearance images of radish of Experimental Examples 10-B-1 to 10-B-9 grown in the test section B.

### EMBODIMENTS FOR CARRYING OUT THE INVENTION

Hereinafter, the present invention will be described in detail.

### 1. Plant Cultivation Method

The plant cultivation method of the present invention is characterized by including a step of grasping tide-generating force and a step of controlling plant growth conditions according to the variation in the tide-generating force.

The tide-generating force may be indicated using, as an index, at least one of relative gravity acceleration (theoretical value), lunar calendar, weather data (atmospheric pressure and tidal level), and distance from the center of the earth to a cultivation spot.

Particularly in the plant cultivation method of the present invention, the relative gravity acceleration is preferably used as the index of the tide-generating force. Namely, it is preferable to grasp the relative gravity acceleration and to control plant growth conditions according to the relative gravity acceleration.

The relative gravity acceleration (RGA) means a relative value of gravity acceleration based on the standard gravity acceleration (1G=9.80665×10⁸ ρGal) as a reference (zero point).

The relative gravity acceleration can be calculated by utilizing a commonly-publicized tidal force prediction program. Specifically, the relative gravity acceleration at a target spot and the temporal change thereof can be calculated by inputting information on a position of the cultivation spot (latitude and longitude), date (year, month and day) and time in the tidal force prediction program.

As the tidal force prediction program, the tide prediction system “GOTIC2” (http://www.miz.nao.ac.jp/staffs/nao99/) or the like can be used.

Specific examples of the growth conditions include lighting, temperature, humidity, water spray, soil, fertilization, carbon dioxide concentration, atmospheric pressure, acoustic wave, vibration, chemical substance concentration, electric stimulation, and the like.

In the plant cultivation method of the invention, it is preferable that plant growth conditions including lighting condition according to the tide-generating force is controlled and more preferable that plant growth conditions including lighting condition according to the relative gravity acceleration is controlled.

An example of the method including the control of the lighting according to the relative gravity acceleration is an embodiment in which a plant is grown under dark condition during a specific time period.

Specifically, a plant may be grown under dark condition in a time period when the relative gravity acceleration changes from plus to minus based on the standard gravity acceleration. More specifically, a plant may be grown while allocating a time period when the relative gravity acceleration changes from plus to minus, to a dark period in light-dark cycle.

A growing time for the plant under dark condition is not particularly limited. The plant is grown under dark condition preferably from at least 0.1 to 12 hours, more preferably from 0.5 to 8 hours, and specifically from 0.5 to 4 hours, immediately after the relative gravity acceleration changes from plus to minus.

An example of the method including the control of the lighting according to the relative gravity acceleration is an embodiment in which a plant is grown under dark condition in a time period when the relative gravity acceleration changes from minus to plus based on the standard gravity acceleration. More specifically, a plant may be grown while allocating a time period when the relative gravity acceleration changes from minus to plus, to a dark period in light-dark cycle.

A growing time for the plant under dark condition is not particularly limited. The plant is grown under dark condition preferably from at least 0.1 to 12 hours, more preferably from 0.5 to 8 hours, and specifically from 0.5 to 4 hours, immediately after the relative gravity acceleration changes from minus to plus.

A length for the light period and a length for the dark period in light-dark cycle are not particularly limited and are appropriately adjusted according to a temporal change in the relative gravity acceleration, circadian rhythm, types of the plant to be grown, and the like. In the light-dark cycle, the length for the light period may be 0 to 24 hours, preferably from 12 to 20 hours, and particularly from 12 to 16 hours, and the length for the dark period may be 0 to 24 hours, preferably from 4 to 12 hours, and particularly from 8 to 12 hours.

In the present invention, a place having an illumination ranging from 0 to 1,500 lux is a dark place (dark condition), and a place having an illumination ranging higher than 1,500 lux is a light place (light condition). The dark condition refers to light intensity at a light compensation point of sun plants (reference document; Taiz and Zeiger, Plant Physiology Third Edition, year of publication; 2002, corresponding page; 178).

In the present invention, types of the plant to be grown are not particularly limited.

Examples of the plant include angiosperm, gymnosperm, pteridophyte, bryophyta, Eumycota, and the like.

The angiosperm may be Dicotyledoneae or Monocotyledoneae. Among the angiosperm, a plant allowing collection of fibers, and a vegetable such as fruit vegetable, leaf vegetable, stem vegetable, root vegetable and flower vegetable are preferred. Specific examples of the plant allowing collection of fibers include kenaf, hemp, jute hemp, ramie, flax, Manila hemp, sisal hemp, Diplomorpha sikokiana, paper birch, paper mulberry, banana, pineapple, curaua, coconut palm, corn, sugarcane, bagasse, palm, papyrus, reed, esparto, sabai grass, wheat, rice, bamboo, cotton flower, kapok, and the like. Other examples thereof include hardwood such as poplar, beech, birch, pillow and maple. Among them, a bast plant such as kenaf, hemp, jute hemp, ramie and flax is particularly preferred.

Specific examples of the vegetable include ones belonging to Malvales including Malvaceae such as okra, and Tiliaceae such as Jew's mallow; Nymphaeales including Nymphaeaceae such as lotus; Violales including Cucurbitaceae such as cucumber, watermelon and melon; Umbelliflorae including Araliaceae such as Aralia cordata, and Apiaceae such as Angelica keiskei, celery, parsley and Cryptotaenia japonica; Caryophyllales including Chenopodiaceae such as spinach; Rosales including Rosaceae such as strawberry, and Capparales including Brassicaceae such as turnip, cauliflower, qing-geng-cai, radish and Chinese cabbage; Fabales including Leguminosae such as azuki, pea, soybean and peanut; Sapindales including Rutaceae such as Japanese pepper; Asterales including Asteraceae such as chrysanthemum, burdock, Petasites japonica and lettuce; Scrophulariales including Pedaliaceae such as sesame; Lamiales including Labiatae such as perilla, basil and peppermint; Solanales including Solanaceae such as small green pepper, potato, tomato, eggplant and bell pepper, and Convolvulaceae such as sweet potato; Alismatales including Alismataceae such as arrowhead; Cyperales including Gramineae such as corn; Arales including Araceae such as konjac and taro; Zingiberales including Zingiberaceae such as ginger and Japanese ginger; Liliales including Iridaceae such as saffron, Dioscoreacea such as Chinese yam, and Liliaceae such as asparagus, onion and Chinese chive; and the like.

The gymnosperm is preferably ones allowing collection of fibers. Specific examples thereof include a conifer such as cedar, Japanese cypress, spruce tree, Abies firma, pine and Japanese larch.

Further, the pteridophyte is preferably a vegetable. Specific examples thereof include ones belonging to Filicales including Polypodiaceae such as bracken, and Osmundaceae such as osmund; Equisetales including Equisetaceae such as horsetail; and the like.

In addition, the Eumycetes is preferably a vegetable. Specific examples thereof include ones belonging to Auriculariales including Auriculariaceae such as cloud ear mashroom; Agaricales including Tricholomataceae such as enoki mashroom, shiitake mashroom and matsutake mashnoom, Agaricaceae such as mushroom, and strophariaceae such as Pholiota nameko; and the like.

### 2. Plant Cultivation Device

The plant cultivation device of the present invention is one having a growing space for cultivating a plant and is characterized by including a means of grasping a tide-generating force, and a growth conditions controlling means for controlling a plant growth conditions in the growing space according to the variation in the tide-generating force.

The growing space may be opened or closed, and may be appropriately adjusted according to types of the plant to be grown, and the like.

Examples of the tide-generating force grasping means include a relative gravity acceleration calculation means in which the relative gravity acceleration is calculated, a means in which the tide-generating force is grasped from the lunar calendar, a means in which the tide-generating force is grasped from weather data such as atmospheric pressure and tidal level, a means in which a distance calculated from the center of the earth to the cultivation spot to grasp the tide-generating force, and the like. Among these means, the relative gravity acceleration calculation means is preferred.

In the relative gravity acceleration calculation means, when information including a position of the plant cultivation spot (latitude and longitude), date (year, month and day) and time is input, the relative gravity acceleration at a target spot and the temporal change thereof are calculated. For the relative gravity acceleration, a commonly-publicized tidal force prediction program can be utilized, as described above.

The growth conditions controlling means controls a growth conditions in the growing space, such as lighting, temperature, humidity, water spray, soil, fertilization, carbon dioxide concentration, atmospheric pressure, acoustic wave, vibration, chemical substance concentration and electric stimulation according to the variation of the tide-generating force (for example, a data that is obtained by the tide-generating force grasping means, such as the calculated relative gravity acceleration).

Particularly in the plant cultivation device of the present invention, it is preferable that the tide-generating force grasping means includes a means of calculating relative gravity acceleration, and the growth conditions controlling means includes a means of controlling a plant growth conditions in the growing space according to the calculated relative gravity acceleration.

Further, the growth conditions including lighting condition is preferably controlled according to the relative gravity acceleration in the plant cultivation device of the present invention.

An example of the method including the control of the lighting according to the relative gravity acceleration is an embodiment in which a plant is grown under dark condition in a time period when the relative gravity acceleration changes from plus to minus based on the standard gravity acceleration. More specifically, a plant may be grown while allocating a time period when the relative gravity acceleration changes from plus to minus, to a dark period in light-dark cycle.

An example of the method including the control of the lighting according to the relative gravity acceleration is an embodiment in which a plant is grown under dark condition in a time period when the relative gravity acceleration changes from minus to plus based on the standard gravity acceleration. More specifically, a plant may be grown while allocating a time period when the relative gravity acceleration changes from minus to plus, to a dark period in light-dark cycle.

### EXAMPLES

Hereinafter, the present invention will be specifically described using Examples.

### 1. Plant Cultivation Device (Example 1)

A plant cultivation device of Example 1 includes, as shown in FIG. 1, a controller 1, a lighting apparatus 3, and a growing space 5.

The controller 1 may be realized by either hardware or software, and is preferably composed of a central microcontroller (microcomputer) including a CPU, a memory such as ROM and RAM, and an input-output circuit, and a peripheral circuit such as an input-output interface. The controller 1 functions as a relative gravity acceleration calculating means that calculates relative gravity acceleration and as a growth conditions controlling means that controls growth conditions in the growing space 5 according to the calculated relative gravity acceleration.

The lighting apparatus 3 includes an LED, a bulb, electroluminescence (EL) or the like as a light source. The controller 1 can adjust the on-off and illumination of the lighting apparatus 3.

The lighting apparatus 3 may use natural light such as sunlight. In this case, it includes a curtain, a blind, a shutter, a door capable of shielding or reducing light or the like, and the illumination can be adjusted by controlling the opening and shutting thereof.

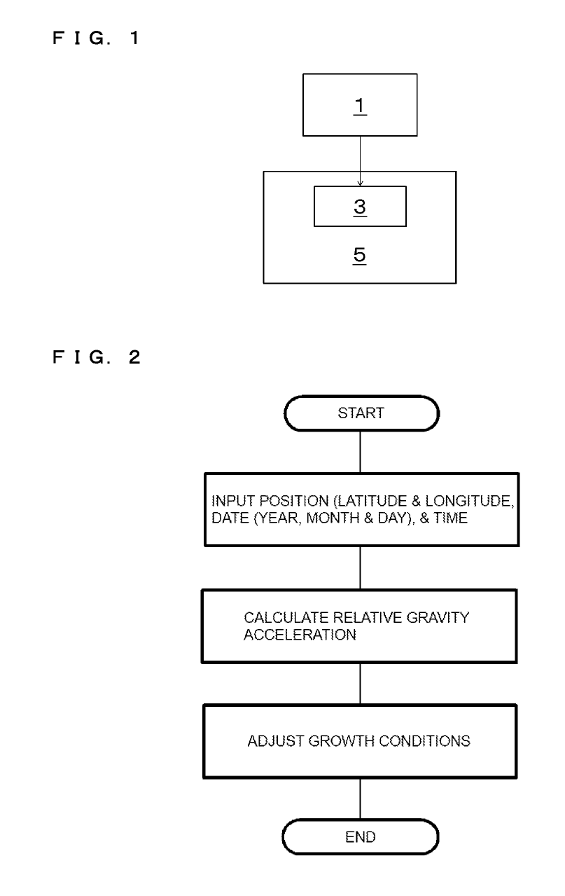

As shown in FIG. 2, the controller 1 calculates the relative gravity acceleration and its temporal change using a tidal prediction program upon the input of each of data including the positional information (latitude and longitude) of the site of cultivation where the plant cultivation device is installed, date, and time. Subsequently, the growth conditions such as lighting condition, temperature condition, humidity condition, water spray condition, soil condition and fertilization conditions are adjusted according to the calculated relative gravity acceleration. Specifically, the lighting apparatus 3 adjusts the lighting condition.

### 2. Plant Cultivation

### 2-1. Experimental Examples 1 to 4

Kenaf was grown for 24 hours using the plant cultivation device of Example 1. The cultivation temperature was set to room temperature (25° C.), and the lighting condition used a light-dark cycle of 16 hours light condition (4 to 20 o'clock) and 8 hours dark condition (20 to 4 o'clock).

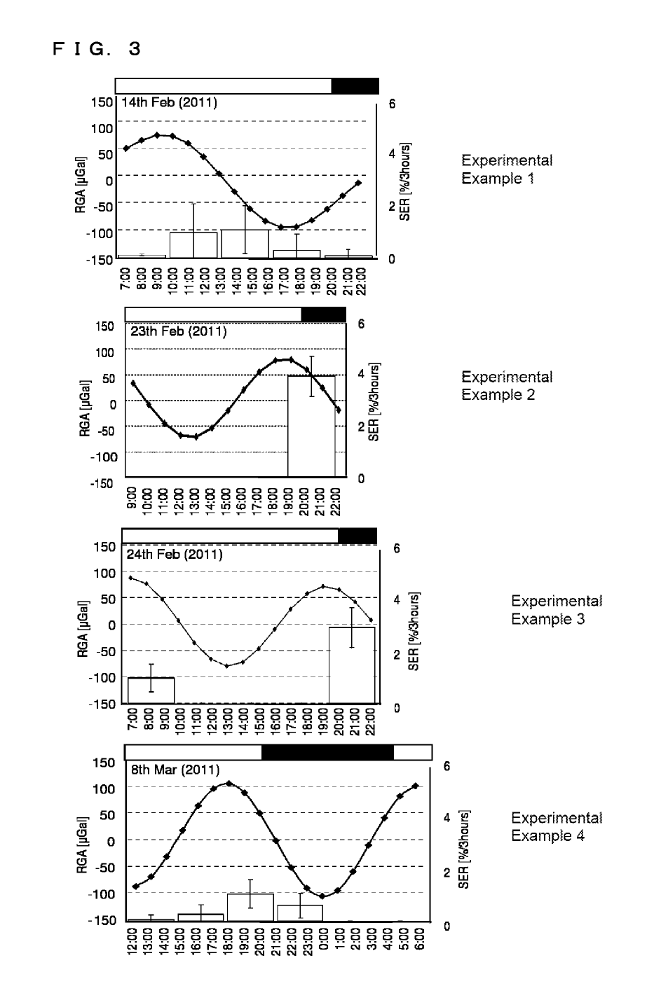

At that time, kenaf after a lapse of about 3 weeks after seeding in the growing space was used for growing. The length of kenaf stem was measured every 3 hours, and the average growth rate (Variation of stem elongation rate (SER)) of the stem in 3 hours was calculated. The result is shown in FIG. 3. The measurement was carried out 4 times (7 to 22 o'clock on Feb. 14, 2011, 9 to 22 o'clock on Feb. 23, 2011, 7 to 22 o'clock on Feb. 24, 2011, and 12 o'clock on March 8 to 6 o'clock on the next day (March 9), 2011), and the number of n on each measurement day was 34 (total number of n: 136).

The curve in FIG. 3 shows the temporal change in the relative value (relative gravity acceleration (μGal)) of the gravitational acceleration calculated using the tidal prediction system “GOTIC2” (http://www.miz.nao.ac.jp/staffs/nao99/) with the standard gravitational acceleration as a standard (zero point).

The horizontal bar graph at upper portion in the drawing shows the light-dark conditions, and the white part indicates a light condition, and the black part indicates a dark condition.

According to FIG. 3, increase of the growth rate of the stem was confirmed in a time period when the relative gravity acceleration changes from plus to minus in all of Experimental Examples 1 to 4.

### 2-2. Experimental Example 5

Kenaf was grown for continuous 8 days using the plant cultivation device of Example 1 (Day 1 is 24 hours from 10 o'clock on Dec. 7, 2011 to 10 o'clock on the next day (December 8)). The cultivation temperature was set to room temperature (25° C.), and the lighting condition used a light-dark cycle of 16 hours light condition (4 to 20 o'clock) and 8 hours dark condition (20 to 4 o'clock).

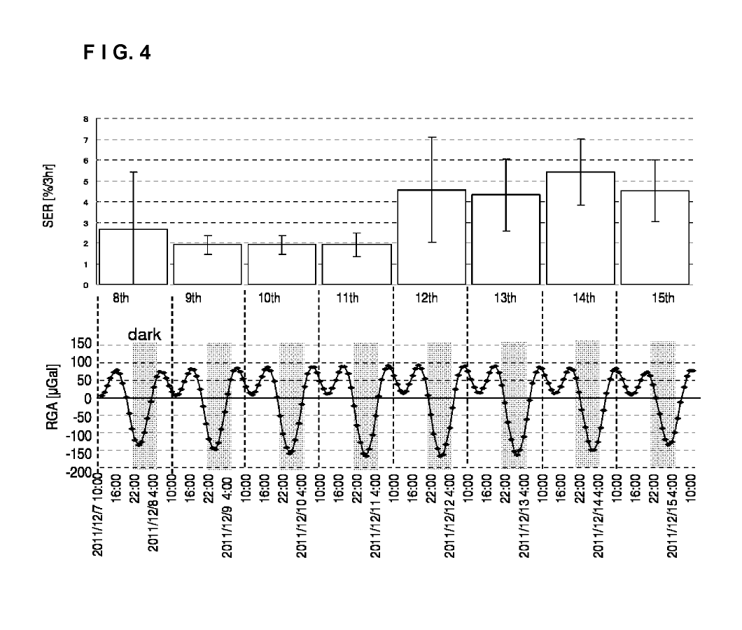

At that time, kenaf after a lapse of about 3 weeks after seeding in the growing space was used for growing. The length of kenaf stem was measured every 24 hours, and the average growth rate (Variation of stem elongation rate (SER)) of the stem in 3 hours was calculated. The result is shown in FIG. 4. The number of n is 34.

According to FIG. 4, increase of the growth rate of the stem was confirmed in the case where the dark period includes a time period when the relative gravity acceleration changes from plus to minus. More specifically, it was confirmed that the stem growth rate per day was higher by cultivating a plant with allocation to the dark period the time period when the relative gravity acceleration changes from plus to minus, as compared to a case where the time period is allocated to the light period.

Therefore, it was found that the plant growth had a close relation with the temporal change of the relative gravity acceleration, and the plant markedly grew in the time period including a time point when the relative gravity acceleration changes from plus to minus. Furthermore, it was confirmed that the plant growth was able to be more efficiently promoted to reduce the cultivation period by cultivating the plant with allocation to the dark period a time period when the relative gravity acceleration changes from plus to minus, because enhancement of the plant growth rate by the change of the relative gravity acceleration overlaps with the dark period when the capacity of using the energy saved by photosynthesis increases.

The use of the plant cultivation device of Example 1 allows easy control of the growth conditions according to the relative gravity acceleration, whereby the plant growth can be efficiently promoted, and the cultivation period can be reduced.

### 3. Plant Cultivation (Study of Biomass Increase Effect (i))

### Experimental Example 6 (Cultivation of Radish) and Experimental Example 7 (Cultivation of Mini Qing-Geng-Cai)

Seeds of radish and mini qing-geng-cai were respectively placed on filter paper which thoroughly absorbed water, and germinated over several days in a moistened state under photoirradiation with a fluorescent lamp. Subsequently, the weight of a plant body of about 1 cm having developed seed leaves was measured for each of radish and mini qing-geng-cai, and 30 individuals having the similar size were selected from both of them and were transplanted to culture pots containing commercially available culture soil for vegetables (trade name “Soil for Vegetable”, manufactured by Daiso Industries Co., Ltd.).

After the transplantation, the pots were transferred into an artificial weather room (model number “TGH-3-P”, manufactured by Espec Corporation) adjusted at an illumination of 50,000 lux, a humidity of 50%, and a temperature of 25° C. to conduct a cultivation experiment. The measurement value of the illumination immediately above the plant body was about 25,000 lux.

In this cultivation experiment, a synchronous cultivation performed by synchronizing a dark condition (dark period), i.e., the light-out time with the behavior of the tide-generating force, and an asynchronous cultivation performed under light-dark cycle of 16 hours light condition (8 to 24 o'clock) and 8 hours dark condition (24 to 8 o'clock) without synchronization with the above-described behavior were carried out.

In the synchronization cultivation experiment of the tide-generating force and the dark period, a time period when relative gravity acceleration as an index of the tide-generating force turns from plus to minus at the site of cultivation (Kariya-shi, Aichi, Japan) was calculated by the above-described tidal prediction system “GOTIC2”, and 8 hours of the dark period was synchronized with the time period (4 hours before and after the point when the relative gravity acceleration turns from plus to minus). Relative gravity accelerations at high tide and low tide vary every time, and a point when the relative gravity acceleration turns from plus to minus may occur twice about a day. In that case, in the comparison of the range from the low tide to the next high tide including the point of turning from plus to minus, adjustment was carried out such that the dark period was given in a wide amount of change in the value of the relative gravity acceleration. Accordingly, the dark period remains 8 hours, but the tide-generating force is not 24 hours cycle, so that the light period in one day is about 16 hours and inconstant.

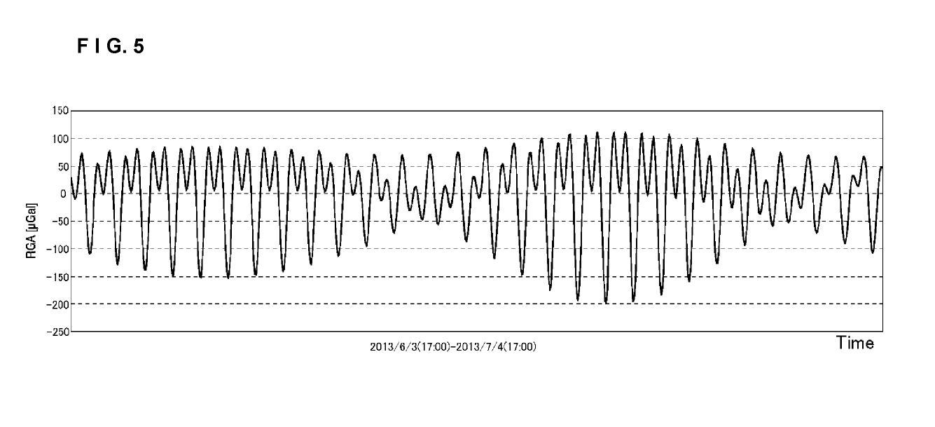

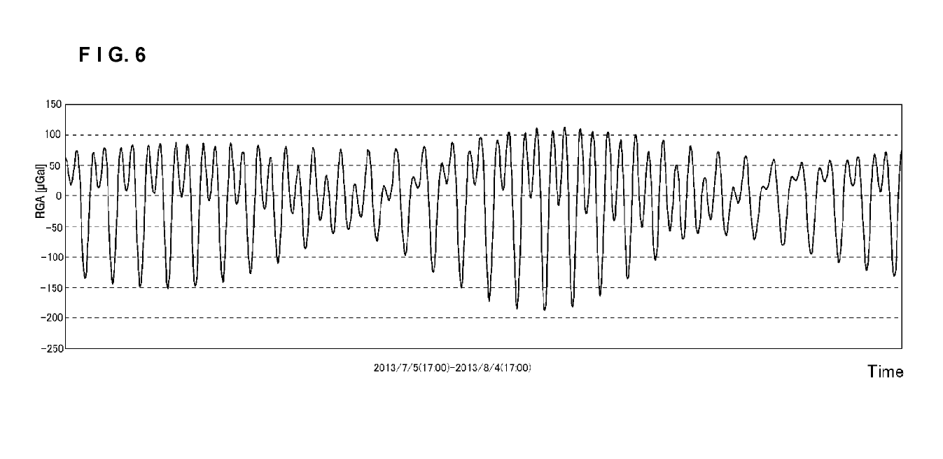

Under the above-described conditions, radish and mini qing-geng-cai were subjected to cultivation experiments (synchronous cultivation and asynchronous cultivation) for about one month. The asynchronous cultivation was carried out from Jun. 3, 2013 (17 o'clock) to Jul. 4, 2013 (17 o'clock), and the synchronous cultivation was carried out from Jul. 5, 2013 (17 o'clock) to Aug. 4, 2013 (17 o'clock). The tide-generating forces (using the change in relative gravity acceleration as an index) in these cultivation periods are considered to behave in almost the same manner as shown in FIGS. 5 and 6.

Each of the plant bodies after cultivation was measured for fresh weight (average of 30 individuals) and dry weight (average of 30 individuals) after washing the culture soil off, and the results are shown in Table 1. Table 1 also included the total time of the dark period overlapping with the specific time period (4 hours before and after the point when the relative gravity acceleration turns from plus to minus) in the cultivation period.

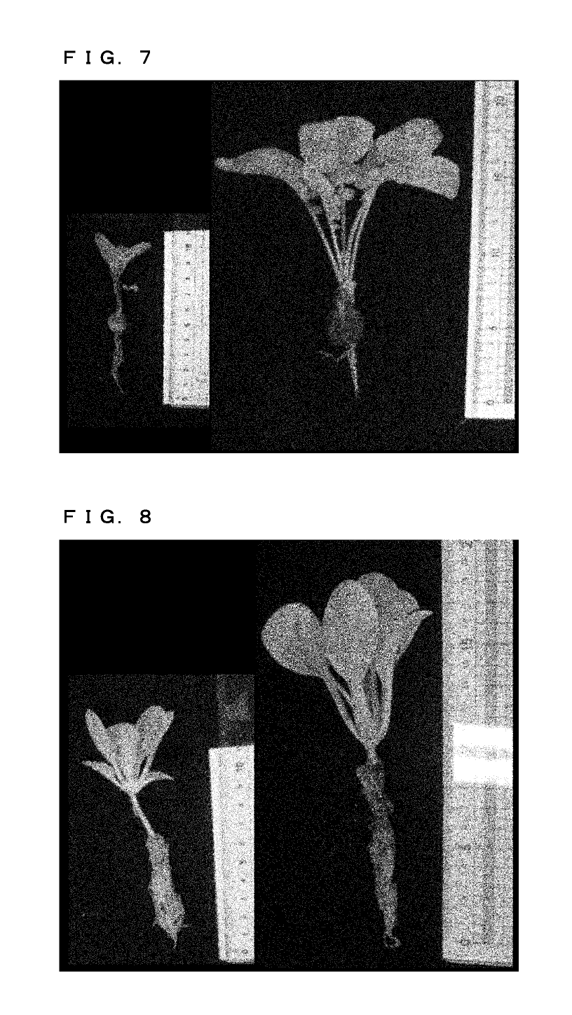

FIG. 7 shows the radish (left drawing) grown by asynchronous cultivation and the radish (right drawing) grown by synchronous cultivation for comparison. FIG. 8 shows the mini qing-geng-cai (left drawing) grown by asynchronous cultivation and the mini qing-geng-cai (right drawing) grown by synchronous cultivation for comparison.

TABLE 1

| | Radish | | | Mini qing-geng-cai | | |
|---|---|---|---|---|---|---|
| | Asynchronous | Synchronous | Weight | Asynchronous | Synchronous | Weight |
| | cultivation | cultivation | ratio | cultivation | cultivation | ratio |
| | (a) | (b) | (b/a) | (a) | (b) | (b/a) |
| Fresh weight (mg) | 1418 | 5428 | 3.83 | 1682 | 5955 | 3.54 |
| Dry weight (mg) | 224 | 453 | 2.02 | 317 | 734 | 2.32 |
| Total time of dark | 104 | 240 | — | 104 | 240 | — |
| period overlapping | | | | | | |
| with specific time | | | | | | |
| period (relative | | | | | | |
| gravity acceleration | | | | | | |
| changes from plus to | | | | | | |
| minus) (h) | | | | | | |

The results in Table 1, FIGS. 7 and 8 indicated that the biomass increases 3 times or more in terms of the fresh weight, and twice or more in terms of the dry weight in the synchronous cultivation experiment, in comparison with the asynchronous cultivation experiment.

Accordingly, it was confirmed that the plant metabolism can be changed by controlling the plant growth conditions (lighting condition) according to the variation of the tide-generating force, and that the plant growth can be promoted, and the biomass can be increased in particular.

### 4. Plant Cultivation (Study of Component Improvement)

### Experimental Example 8 (Cultivation of Lettuce)

Seeds of lettuce generally cultivated in plant factories (“Frill Ice”, Snow Brand Seed Co., Ltd.) were placed on a urethane base for hydroponic culture which thoroughly absorbed water, and induced to germinate at 25° C. in a dark place for 2 days. After germination, individuals grown to the same degree were chosen, and transplanted on a tray for hydroponic culture, 12 plants on each tray. They were transferred into three growth chambers (type name “LPH-410SPCS” manufactured by Nippon Medical & Chemical Instruments Co., Ltd.) adjusted at an illumination of about 18,000 lux, a humidity of 50%, and a temperature of 25° C., and subjected to the following cultivation experiment. For the hydroponic culture, used was a small type hydroponic culture apparatus manufactured by ESPEC MIC Corporation, and the hydroponic culture solution was prepared according to the “mixture A formulation” for “Otsuka House No. 1” and “Otsuka House No. 2” of solution culture fertilizers (manufactured by OTA Agrio Co., Ltd.). The hydroponic culture solution was replaced once to twice in one week.

In the cultivation experiment, two of the three growth chambers were subjected to synchronous cultivation in which the dark condition (dark period), i.e., the light-out time was synchronized with the behavior of the tide-generating force, and the rest one growth chamber was subjected to asynchronous cultivation in which cultivation was carried out under a light-dark cycle of 16 hours light condition (6 to 22 o'clock) and 8 hours dark condition (22 to 6 o'clock) without synchronization with the above-described behavior. Of the two synchronous cultivations, one cultivation was carried out in the same manner as in the synchronous cultivation of Experimental Example 7 by calculating the time period when the relative gravity acceleration as an index of the tide-generating force turns from plus to minus at the site of cultivation (Kariya-shi, Aichi, Japan) with the use of the above-described tidal prediction system “GOTIC2”, and synchronizing 8 hours of the dark period with the time period. The rest one cultivation was carried out by calculating the time period when the relative gravity acceleration turns from minus to plus with the use of the above-described system, and synchronizing 8 hours of the dark period with the time period.

Under the above-described conditions, each of the cultivation experiments (synchronous cultivation and asynchronous cultivation) was carried out in parallel from Jan. 26, 2014 (15 o'clock) to Feb. 25, 2014 (15 o'clock). The accumulated amounts of irradiation during the cultivation period were the same between the experiments. During the plant cultivations, thinning was carried out as necessary.

Finally, 6 individuals grown to have a diameter of about 20 cm were cropped in each cultivation experiment, and subjected to component analyses (I) and (II) as follows. The results of the component analysis (I) are shown in Table 2, and the results of the component analysis (II) are shown in Table 3. Tables 2 and 3 also included the total time of the dark period overlapping with the specific time period (a) (4 hours before and after the point when the relative gravity acceleration turns from plus to minus) in the cultivation period, and the total time of the dark period overlapping with the specific time period (b) (4 hours before and after the point when the relative gravity acceleration turns from minus to plus) in the cultivation period.

In the tables, the “test section 1 (asynchronous)” includes results for the asynchronous cultivation experiment. In addition, the “test section 2 (synchronous (plus->minus))” includes results of the synchronous cultivation in which 8 hours of the dark period was synchronized with the time period when the relative gravity acceleration turns from plus to minus. Furthermore, the “test section 3 (synchronous (minus->plus))” includes results of the synchronous cultivation in which 8 hours of the dark period was synchronized with the time period when the relative gravity acceleration turns from minus to plus.

### Component Analysis (I)

The cropped 3 individuals (from test sections 1-1 to 1-3, 2-1 to 2-3, and 3-1 to 3-3) were subjected to nutritional analysis for energy (kcal/100 g), moisture (g/100 g), protein (g/100 g), lipid (g/100 g), carbohydrate (g/100 g), and ash (mineral) (g/100 g). The averages were also calculated.

The analysis method for each component is as follows.

Energy: calculation method

Moisture: decompression heating drying method

Protein: Kjeldahl method

Lipid: acidolysis method

Carbohydrate: calculation method

Ash: direct ashing method

### Component Analysis (II)

The cropped 3 individuals (from test sections 1-4 to 1-6, 2-4 to 2-6, 3-4 to 3-6) were subjected to nutritional analysis for various minerals including sodium (mg/100 g), potassium (mg/100 g), calcium (mg/100 g), magnesium (mg/100 g), phosphorus (mg/100 g), iron (mg/100 g), zinc (mg/100 g), and manganese (mg/100 g). The averages were also calculated.

For the analysis of these components, used was inductively coupled plasma (ICP) optical emission spectrometry.

TABLE 2

| | | | | | Test section 2 | | | | | | | |
|---|---|---|---|---|---|---|---|---|---|---|---|---|
| | Test section 1 | | | | (synchronous | | | | Test section 3 | | | |
| | (asynchronous) | | | | (plus -> minus)) | | | | (synchronous (minus -> plus)) | | | |
| | 1-1 | 1-2 | 1-3 | Average | 2-1 | 2-2 | 2-3 | Average | 3-1 | 3-2 | 3-3 | Average |
| Fresh weight (g) | 213 | 223 | 214 | 216.7 | 202 | 170 | 194 | 188.7 | 186 | 190 | 238 | 204.7 |
| Energy (kcal/100 g) | 20 | 19 | 20 | 19.7 | 23 | 22 | 23 | 22.7 | 19 | 19 | 20 | 19.3 |
| Moisture (g/100 g) | 94.6 | 94.8 | 94.4 | 94.6 | 93.7 | 94 | 93.6 | 93.8 | 94.7 | 94.7 | 94.5 | 94.6 |
| Protein (g/100 g) | 1.5 | 1.5 | 1.5 | 1.50 | 1.6 | 1.6 | 1.6 | 1.60 | 1.4 | 1.4 | 1.5 | 1.43 |
| Lipid (g/100 g) | 0.3 | 0.3 | 0.3 | 0.3 | 0.3 | 0.3 | 0.3 | 0.3 | 0.3 | 0.3 | 0.3 | 0.3 |
| Carbohydrate (g/100 g) | 2.7 | 2.5 | 2.9 | 2.7 | 3.4 | 3.1 | 3.5 | 3.3 | 2.6 | 2.6 | 2.8 | 2.7 |
| Ash (g/100 g) | 0.9 | 0.9 | 0.9 | 0.9 | 1.0 | 1.0 | 1.0 | 1.0 | 1.0 | 1.0 | 0.9 | 1.0 |

| | | | | | | |
|---|---|---|---|---|---|---|
| Total time of dark | 104 | — | 240 | — | 0 | — |
| period overlapping | | | | | | |
| with specific time | | | | | | |
| period (relative | | | | | | |
| gravity acceleration | | | | | | |
| changes from plus to | | | | | | |
| minus) (hours) | | | | | | |
| Total time of dark | 136 | — | 0 | — | 240 | — |
| period overlapping | | | | | | |
| with specific time | | | | | | |
| period (relative | | | | | | |
| gravity acceleration | | | | | | |
| changes from minus to | | | | | | |
| plus) (hours) | | | | | | |

TABLE 3

| | Test section 1 | | | | Test section 2 | | | | Test section 3 | | | |
|---|---|---|---|---|---|---|---|---|---|---|---|---|
| | (asynchronous) | | | | (synchronous (plus -> minus)) | | | | (synchronous (minus -> plus)) | | | |
| | 1-4 | 1-5 | 1-6 | Average | 2-4 | 2-5 | 2-6 | Average | 3-4 | 3-5 | 3-6 | Average |
| Fresh weight (g) | 220 | 227 | 237 | 228.0 | 178 | 175 | 199 | 184.0 | 201 | 197 | 191 | 196.3 |
| Sodium (mg/100 g) | 2.9 | 2.3 | 2.6 | 2.60 | 2.7 | 2.2 | 2.9 | 2.60 | 3.7 | 2.6 | 2.3 | 2.87 |
| Potassium (mg/100 g) | 408 | 414 | 395 | 405.7 | 444 | 433 | 423 | 433.3 | 434 | 416 | 417 | 422.3 |
| Calcium (mg/100 g) | 61 | 65 | 62 | 62.7 | 59 | 62 | 60 | 60.3 | 61 | 63 | 59 | 61.0 |
| Magnesium | 24.1 | 26.1 | 24.1 | 24.8 | 21.7 | 22.7 | 23.1 | 22.5 | 24.6 | 24.3 | 22.7 | 23.9 |
| (mg/100 g) | | | | | | | | | | | | |
| Phosphorus | 42 | 46 | 43 | 43.7 | 48 | 45 | 48 | 47.0 | 45 | 46 | 46 | 45.7 |
| (mg/100 g) | | | | | | | | | | | | |
| Iron (mg/100 g) | 0.5 | 0.5 | 0.6 | 0.53 | 0.6 | 0.5 | 0.7 | 0.60 | 0.5 | 0.5 | 0.5 | 0.50 |
| Zinc (mg/100 g) | 0.25 | 0.25 | 0.21 | 0.24 | 0.22 | 0.25 | 0.24 | 0.24 | 0.24 | 0.22 | 0.23 | 0.23 |
| Manganese (mg/100 g) | 0.93 | 1.1 | 0.98 | 1.00 | 0.88 | 0.95 | 0.94 | 0.92 | 0.98 | 1.0 | 0.93 | 0.97 |

| | | | | | | |
|---|---|---|---|---|---|---|
| Total time of dark | 104 | — | 240 | — | 0 | — |
| period overlapping | | | | | | |
| with specific time | | | | | | |
| period (relative | | | | | | |
| gravity acceleration | | | | | | |
| changes from plus to | | | | | | |
| minus) (hours) | | | | | | |
| Total time of dark | 136 | — | 0 | — | 240 | — |
| period overlapping | | | | | | |
| with specific time | | | | | | |
| period (relative | | | | | | |
| gravity acceleration | | | | | | |
| changes from minus to | | | | | | |
| plus) (hours) | | | | | | |

From the results in Tables 2 and 3, changes in the contents of carbohydrate, protein, pottasium and the like were confirmed by matching the lighting condition according to the variation in the tide-generating force.

Accordingly, it was confirmed that the plant metabolism can be changed by controlling the plant growth conditions (lighting condition) according to the variation of the tide-generating force, and that the components can be improved in particular. It is expected that the component improvement also allows an adjustment of the contents of nutrition components, and improvement of taste.

### 5. Plant Cultivation (Study of Biomass Increase Effect (ii))

### Experimental Example 9 (Cultivation of Qing-Geng-Cai)

Seeds of qing-geng-cai (“Very Early Grown Mini 30-Day Qing-geng-cai”, produced by Atariya Noen Co. Ltd.) were allowed to absorb water by placing them on paper towel moistened with tap water, and then seeded one by one in culture pots (3 cm long×3 cm wide×3 cm depth) containing granular culture soil (“Granular Culture Soil for Flower and Vegetable”, LIFELEX). They were germinated over one week in a growth chamber (“LPH-410SPC”, manufactured by Nippon Medical & Chemical Instruments Co., Ltd.) under conditions at a temperature of 25° C., a humidity of 65%, and an illumination of about 15,000 lux.

After that, 40 individuals having similar appearances (the number of leaves and size) were selected from the individuals of about 3 cm having developed cotyledons and two developed foliage leaves. These selected individuals were transplanted in culture pots (5 cm long×5 cm wide×5 cm depth) containing fresh granular culture soil. At that time, the individuals were transplanted to 4 trays, ten individuals to one tray, and these trays were divided into two test sections.

This cultivation experiment was subjected to synchronous cultivation in which the dark condition (dark period), i.e., the light-out time was synchronized with the behavior of the tide-generating force in the same manner as in Experimental Example 8 in test sections A and B. In the test section A, cultivation was carried out by synchronizing 8 hours of the dark period with the time period when the variation of the tide-generating force turns from minus to plus in Kariya-shi, Aichi, Japan (4 hours before and after the point when the relative gravity acceleration turns from minus to plus). On the other hand, in the test section B, cultivation was carried out by synchronizing 8 hours of the dark period with the time period when the variation of the tide-generating force turns from plus to minus in Kariya-shi, Aichi, Japan (4 hours before and after the point when the relative gravity acceleration turns from plus to minus). The behavior of the tide-generating force was calculated by the above-described tidal prediction system “GOTIC2”.

In this cultivation experiment, the initiation day of synchronization was 15:00 on July 3 (Wednesday), 2014, and the cultivation experiment was carried out in the same manner as in the above-described germination induction under conditions at a temperature of 25° C., a humidity of 65%, and an illumination of about 15,000 lux. The trays were taken out from each test section at 13:00 on July 24 (Tuesday), 2014, day 22 from the initiation of the dark period synchronization, and only the above-ground parts of qing-geng-cai were collected.

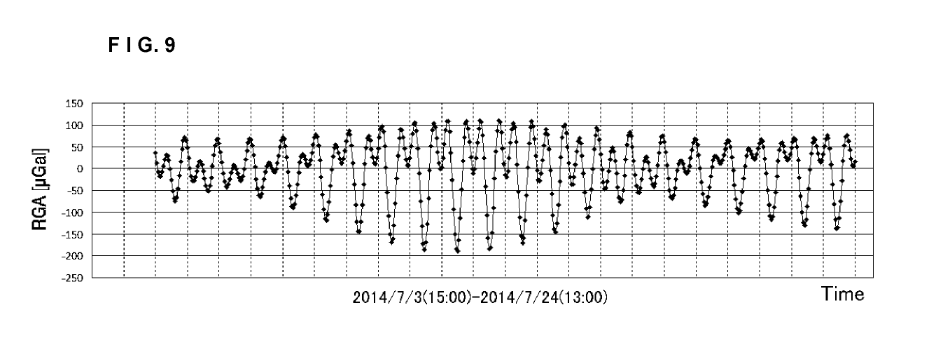

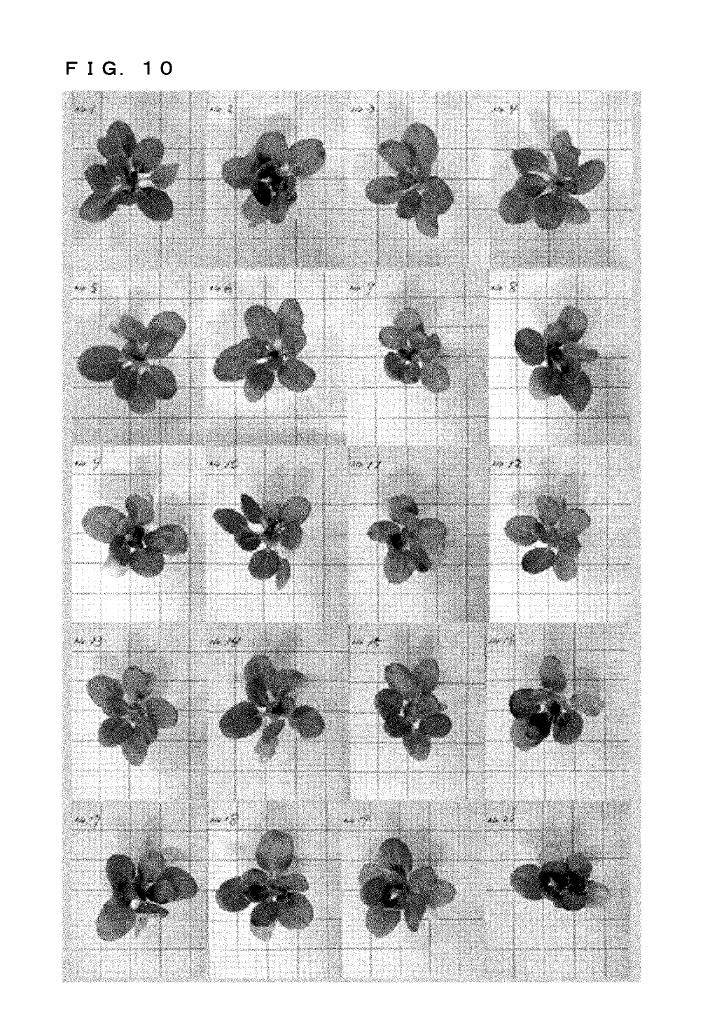

The change in the tide-generating force during the cultivation period (the change in the relative gravity acceleration was used as an index) is as shown in FIG. 9. The accumulated time of the dark period in the cultivation period was 168 hours, and the accumulated time of the light period in the cultivation period was 334 hours, which were the same in all the test sections.

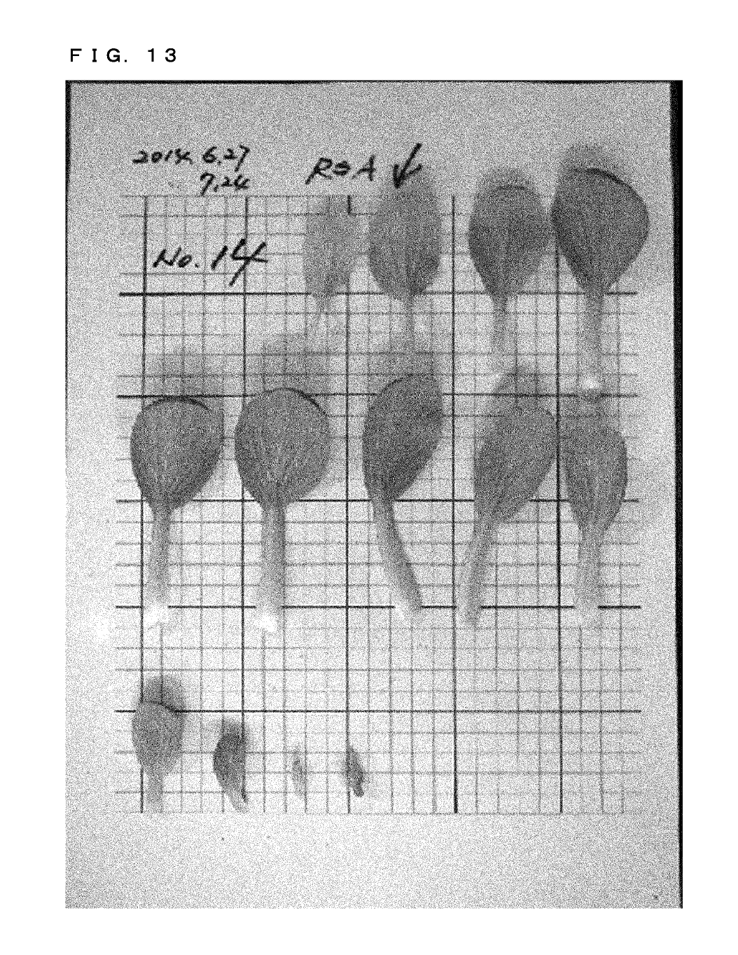

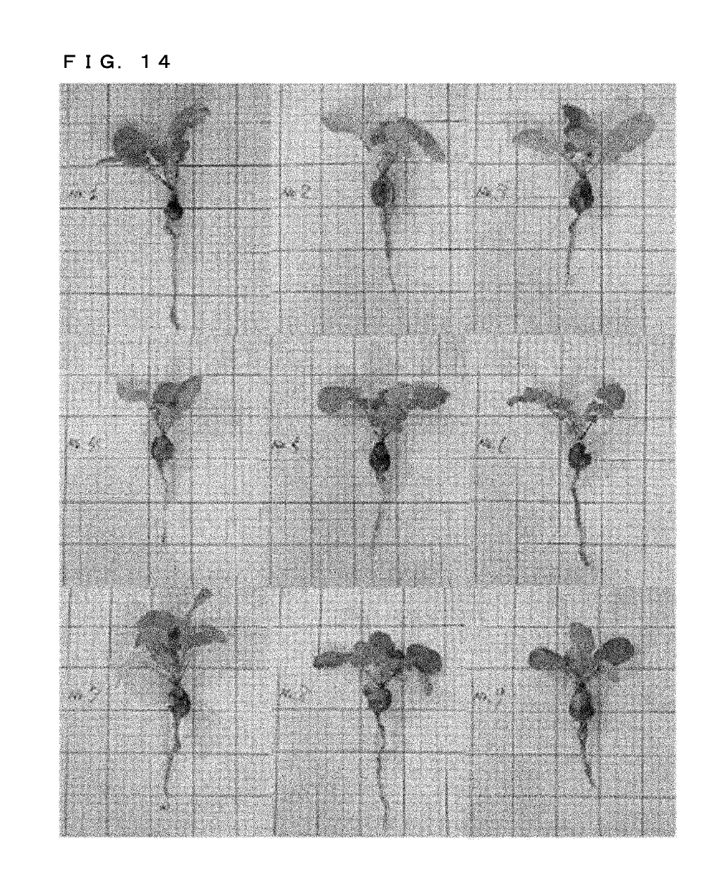

The fresh weight of the above-ground part of the collected qing-geng-cai was measured, and the number of leaves was counted. The results are shown in Table 4. Furthermore, average length of the rachis of five main leaves (the fifth to ninth leaves, see FIGS. 12 and 13) in all the individuals in each test section, and average length of the longest rachis in all the individuals in each test section were calculated. The results are shown in Table 5.

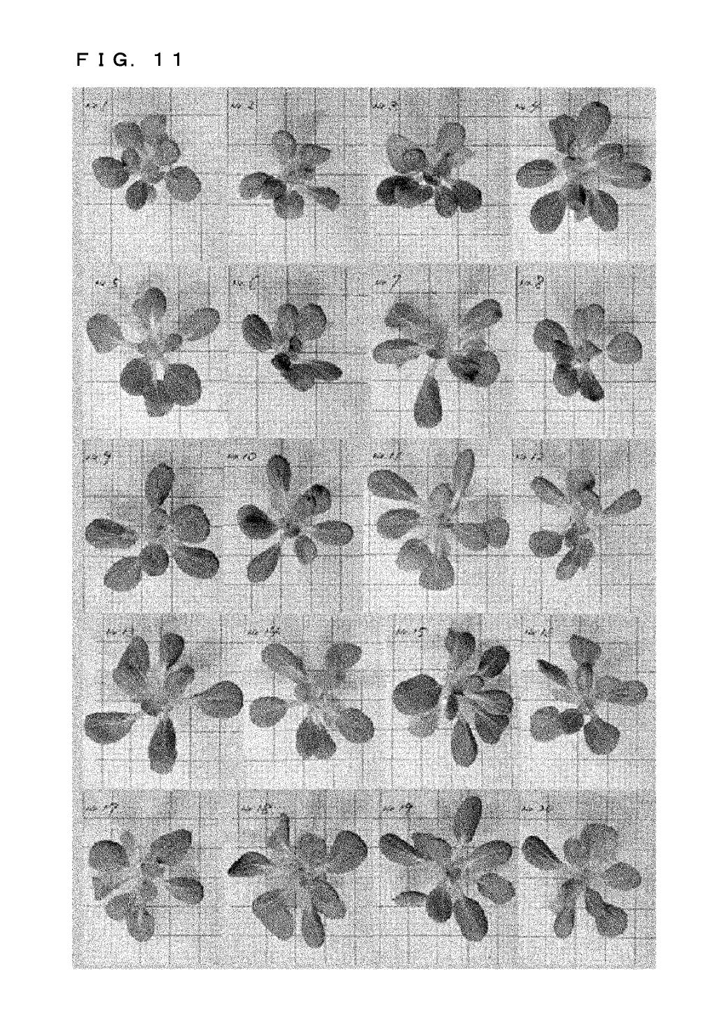

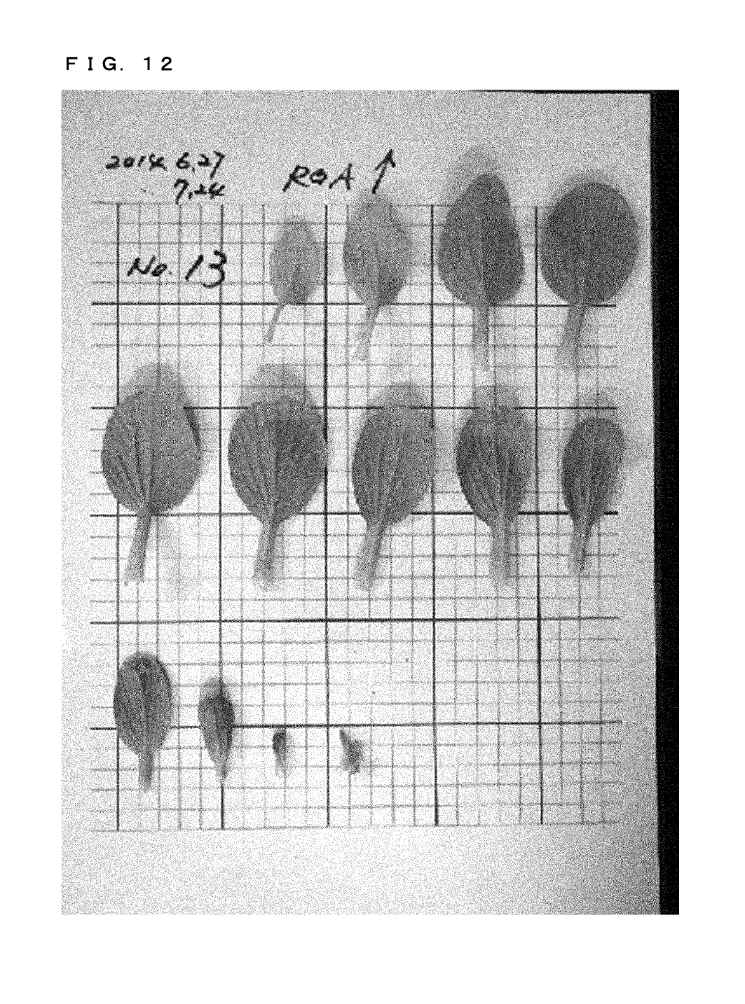

Appearance images of the qing-geng-cai grown in the test section A (dark period synchronization (minus->plus)) in Experimental Examples 9-A-1 to 9-A-20 are shown in FIG. 10, and appearance images of the qing-geng-cai grown in the test section B (dark period synchronization (plus->minus)) in Experimental Examples 9-B-1 to 9-B-20 are shown in FIG. 11. In FIG. 10, Experimental Examples 9-A-1 to 9-A-4 are shown from left to right of the top column, Experimental Examples 9-A-5 to 9-A-8 are shown from left to right of the second column, Experimental Examples 9-A-9 to 9-A-12 are shown from left to right of the third column, Experimental Examples 9-A-13 to 9-A-16 are shown from left to right of the fourth column, and Experimental Examples 9-A-17 to 9-A-20 are shown from left to right of the fifth column. In the same manner as the order in FIG. 10, Experimental Examples 9-B-1 to 9-B-20 are described in FIG. 11.

Appearance images of the leaves of the qing-geng-cai grown in the test section A in Experimental Example 9-A-13 is shown in FIG. 12, and appearance images of the leaves of the qing-geng-cai grown in the test section B in Experimental Example 9-B-14 is shown in FIG. 13. In FIGS. 12 and 13, the first to fourth leaves are shown from left to right of the upper column, the fifth to ninth leaves are shown from left to right of the middle column, and the tenth to thirteenth leaves are shown from left to right of the lower column.

TABLE 4

| | Test section A | | | Test section B | |
|---|---|---|---|---|---|
| | (dark period | | | (dark period | |
| | synchronization: | | | synchronization: | |
| | minus -> plus) | | | plus -> minus) | |
| | Fresh | | | Fresh | |
| | weight of | Number | | weight of | Number |
| | above- | of | | above- | of |
| Experimental | ground | leaves | Experimental | ground | leaves |
| Example | part (g) | (count) | Example | part (g) | (count) |
| 9-A-1 | 9.49 | 15 | 9-B-1 | 10.94 | 13 |
| 9-A-2 | 11.76 | 14 | 9-B-2 | 9.39 | 13 |
| 9-A-3 | 9.58 | 13 | 9-B-3 | 13.52 | 14 |
| 9-A-4 | 11.31 | 13 | 9-B-4 | 14.05 | 15 |
| 9-A-5 | 10.28 | 13 | 9-B-5 | 12.27 | 13 |
| 9-A-6 | 10.49 | 13 | 9-B-6 | 8.70 | 12 |
| 9-A-7 | 7.35 | 12 | 9-B-7 | 13.24 | 13 |
| 9-A-8 | 11.31 | 14 | 9-B-8 | 9.09 | 12 |
| 9-A-9 | 11.25 | 14 | 9-B-9 | 13.79 | 14 |
| 9-A-10 | 9.39 | 13 | 9-B-10 | 11.02 | 13 |
| 9-A-11 | 7.44 | 12 | 9-B-11 | 13.92 | 14 |
| 9-A-12 | 8.18 | 13 | 9-B-12 | 9.58 | 12 |
| 9-A-13 | 8.40 | 13 | 9-B-13 | 15.89 | 15 |
| 9-A-14 | 9.11 | 13 | 9-B-14 | 11.50 | 13 |
| 9-A-15 | 8.19 | 13 | 9-B-15 | 15.18 | 15 |
| 9-A-16 | 8.55 | 13 | 9-B-16 | 13.50 | 13 |
| 9-A-17 | 10.85 | 13 | 9-B-17 | 11.41 | 13 |
| 9-A-18 | 11.01 | 13 | 9-B-18 | 16.52 | 15 |
| 9-A-19 | 10.65 | 14 | 9-B-19 | 14.19 | 14 |
| 9-A-20 | 8.95 | 14 | 9-B-20 | 13.50 | 13 |
| Average | 9.677 | 13.25 | Average | 12.560 | 13.45 |
| Standard | 1.342 | 0.698 | Standard | 2.218 | 0.973 |
| deviation | | | deviation | | |

TABLE 5

| | | Test section A | Test section B |
|---|---|---|---|
| | | (9-A-1 to A-20) | (9-B-1 to B-20) |
| Dark period synchronization | | minus -> plus | plus -> minus |
| Rachis in the fifth | Average | 28.9 | 46.8 |
| to ninth leaves | Standard | 1.70 | 6.36 |
| (mm) | deviation | | |
| Longest rachis | Average | 32.3 | 55.1 |
| (mm) | Standard | 2.83 | 6.07 |
| | deviation | | |

According to the results in Table 4, the fresh weight of the qing-geng-cai (average weight of the above-ground parts) in the test section A (dark period synchronization (minus->plus)) in Experimental Examples 9-A-1 to 9-A-20 grown was 9.677 g. In contrast, the fresh weight of the qing-geng-cai (average weight of the above-ground parts) in the test section A (dark period synchronization (plus->minus)) in Experimental Examples 9-B-1 to 9-B-20 grown was 12.560 g, which was about 1.3 times the result in the test section A, indicating that the qing-geng-cai grown in the test section B was larger than the qing-geng-cai grown in the test section A. The difference in size was apparent also from the comparison of the appearance images in FIG. 10 (cultivation in the test section A) and FIG. 11 (cultivation in the test section B).

In addition, the leaves of the qing-geng-cai were decomposed, and the number of leaves was about 13 in each test section, suggesting that there is no difference between them (see Table 4).

On the other hand, forms of the leaves were observed and compared. It was confirmed that the green color of the leaves (especially the green color of the rachis) was denser in the qing-geng-cai leaves of Experimental Examples 9-A-1 to 9-A-20 than the qing-geng-cai leaves of Experimental Examples 9-B-1 to 9-B-20.

As is evident from FIGS. 12, 13, and Table 5, there was an apparent difference in the size of the rachis. When an average length of the rachis of five main leaves (the fifth to ninth leaves) in each test section was calculated, the average length of the qing-geng-cai in the test section A in Experimental Examples 9-A-1 to 9-A-20 was 28.9 mm. In contrast, an average length of the qing-geng-cai in the test section B in Experimental Examples 9-B-1 to 9-B-20 was 46.8 mm, which was about 1.6 times the result in the test section A. When an average length of the longest rachis in all the individuals in each test section was calculated, the average length of the qing-geng-cai in the test section A in Experimental Examples 9-A-1 to 9-A-20 was 32.3 mm. In contrast, an average length of the qing-geng-cai in the test section B in Experimental Examples 9-B-1 to 9-B-20 was 55.1 mm, which was about 1.7 times the result in the test section A.

### 6. Plant Cultivation (Study of Biomass Increase Effect (iii))

### Experimental Example 10 (Cultivation of Radish)

Seeds of radish (“Akamaru Radish”, Atariya Noen Co. Ltd.) were allowed to absorb water by placing them on paper towel moistened with tap water, and then seeded one by one in culture pots (3 cm long×3 cm wide×3 cm depth) containing granular culture soil (“Granular Culture Soil for Flower and Vegetable”, produced by LIFELEX). They were germinated over one week in a growth chamber (type name “LPH-410SPC”, manufactured by Nippon Medical & Chemical Instruments Co., Ltd.) under conditions at a temperature of 25° C., a humidity of 65%, and an illumination of about 15,000 lux.

After that, 18 individuals having similar appearances (the number of leaves and size) were selected from the individuals of about 3 cm having developed cotyledons and two developed foliage leaves. These selected individuals were transplanted in culture pots (5 cm long×5 cm wide×5 cm depth) containing fresh granular culture soil. At that time, the individuals were transplanted to 2 trays, nine individuals to one tray, and these trays were divided into two test sections.

This cultivation experiment was subjected to synchronous cultivation in which the dark condition (dark period), i.e., the light-out time was synchronized with the behavior of the tide-generating force in test sections A and B. In the test section A, cultivation was carried out by synchronizing 8 hours of the dark period with the time period when the variation of the tide-generating force turns from minus to plus in Kariya-shi, Aichi, Japan (4 hours before and after the point when the relative gravity acceleration turns from minus to plus). On the other hand, in the test section B, cultivation was carried out by synchronizing 8 hours of the dark period with the time period when the variation of the tide-generating force turns from plus to minus in Kariya-shi, Aichi, Japan (4 hours before and after the point when the relative gravity acceleration turns from plus to minus). The behavior of the tide-generating force was calculated by the above-described tidal prediction system “GOTIC2”.

In this cultivation experiment, the initiation day of synchronization was 15:00 on July 3 (Wednesday), 2014, and the cultivation experiment was carried out in the same manner as in the above-described germination induction under conditions at a temperature of 25° C., a humidity of 65%, and an illumination of about 15,000 lux. The trays were taken out from each test section at 13:00 on July 24 (Tuesday), 2014, day 22 from the initiation of the dark period synchronization, and radish was collected.

The change in the tide-generating force during the cultivation period (the change in the relative gravity acceleration was used as an index) is as shown in FIG. 9. The accumulated time of the dark period in the cultivation period was 168 hours, and the accumulated time of the light period in the cultivation period was 334 hours, which were the same in all the test sections.

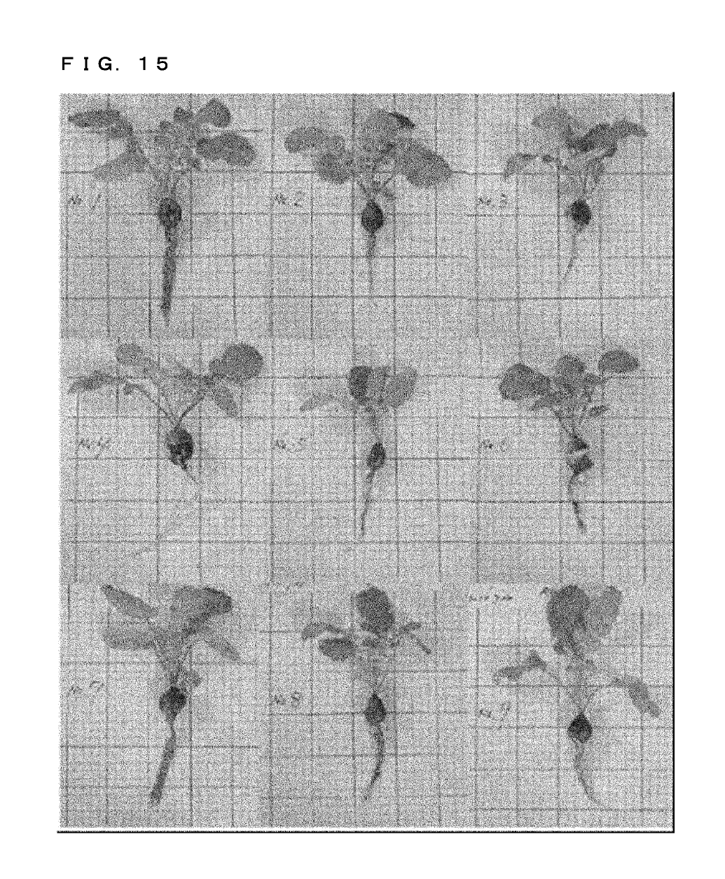

The fresh weights of the above-ground and underground parts, and whole of the collected radish were measured. The results are shown in Table 6. Appearance images of the radish grown in the test section A (dark period synchronization (minus->plus)) in Experimental Examples 10-A-1 to 10-A-9 are shown in FIG. 14, and appearance images of the radish grown in the test section B (dark period synchronization (plus->minus)) in Experimental Examples 10-B-1 to 10-B-9 are shown in FIG. 15.

TABLE 6

| | Test section A | | | | Test section B | | |
|---|---|---|---|---|---|---|---|
| | (dark period synchronization: | | | | (dark period synchronization: | | |
| | minus -> plus) | | | | plus -> minus) | | |
| | Fresh weight (g) | | | | Fresh weight (g) | | |
| Experimental | Above-ground | Underground | | Experimental | Above-ground | Underground | |
| Example | part | part | Whole | Example | part | part | Whole |
| 10-A-1 | 4.01 | 6.00 | 11.01 | 10-B-1 | 7.10 | 14.09 | 23.32 |
| 10-A-2 | 3.09 | 13.82 | 17.96 | 10-B-2 | 5.19 | 12.89 | 18.98 |
| 10-A-3 | 2.76 | 13.71 | 17.36 | 10-B-3 | 6.49 | 12.49 | 19.73 |
| 10-A-4 | 1.95 | 10.85 | 13.76 | 10-B-4 | 4.45 | 24.37 | 30.06 |
| 10-A-5 | 3.29 | 10.44 | 14.46 | 10-B-5 | 2.56 | 7.52 | 11.07 |
| 10-A-6 | 2.08 | 10.60 | 13.63 | 10-B-6 | 5.39 | 13.98 | 20.85 |
| 10-A-7 | 4.21 | 14.14 | 19.44 | 10-B-7 | 6.57 | 14.53 | 23.05 |
| 10-A-8 | 2.77 | 11.58 | 15.38 | 10-B-8 | 3.78 | 10.56 | 15.51 |
| 10-A-9 | 2.15 | 14.01 | 17.04 | 10-B-9 | 5.38 | 11.73 | 18.13 |
| Average | 2.923 | 11.683 | 15.560 | Average | 5.212 | 13.573 | 20.078 |
| Standard | 0.814 | 2.642 | 2.626 | Standard | 1.448 | 4.592 | 5.323 |
| deviation | | | | deviation | | | |

According to the results in Table 6, the fresh weight of the radish (the average weight of the whole) in the test section A (dark period synchronization (minus->plus)) in Experimental Examples 10-A-1 to 10-A-9 grown was 15.560 g. In contrast, the fresh weight of the radish (the average weight of the whole) in the test section B (dark period synchronization (plus->minus)) in Experimental Examples 10-B-1 to 10-B-9 grown was 20.078 g, which was about 1.3 times the result in the test section A, indicating that the radish grown in the test section B was larger than the radish grown in the test section A. The difference in size was apparent also from the comparison of the appearance images in FIG. 14 (cultivation in the test section A) and FIG. 15 (cultivation in the test section B).

In addition, as is evident from the comparison of the appearance images in FIGS. 14 and 15, the difference in size of the radish (the average weight of the whole) was great in the above-ground part (the average weight of the above-ground parts in Experimental Examples 10-A-1 to 10-A-9; 2.923 g, the average weight of the above-ground parts in Experimental Examples 10-B-1 to 10-B-9; 5.212 g, B/A: 1.783), and no such difference was shown in the underground part (the average weight of the underground parts in Experimental Examples 10-A-1 to 10-A-9; 11.683 g, the average weight of the underground parts in Experimental Examples 10-B-1 to 10-B-9; 13.573 g, B/A: 1.162).

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above-described embodiments, and various variations and modifications may be possible without departing from the scope of the present invention.

### INDUSTRIAL APPLICABILITY

According to the plant cultivation method and plant cultivation device of the present invention, the plant growth conditions can be controlled according to the variation in tide-generating force and the plant metabolism can be changed. When relative gravity acceleration that is readily grasped without special facilities is particularly used, the cultivation period can be reduced to improve plant productivity, to increase biomass, or to improve plant components. Therefore, the present invention can be widely used in various fields such as gardening, agriculture and forestry.

### REFERENCE SIGNS LIST

1: controller, 3: lighting apparatus, 5: growing space

1. A plant cultivation method characterized by comprising:
grasping tide-generating force; and
controlling plant growth conditions according to the variation in the tide-generating force.

2. The plant cultivation method according to claim 1,
wherein the plant growth conditions include lighting condition.

3. The plant cultivation method according to claim 1,
wherein relative gravity acceleration is used as an index of the tide-generating force.

4. The plant cultivation method according to claim 3,
wherein a plant is grown under dark condition in a time period when the relative gravity acceleration changes from plus to minus based on the standard gravity acceleration as a reference.

5. The plant cultivation method according to claim 3,
wherein a plant is grown under dark condition in a time period when the relative gravity acceleration changes from minus to plus based on the standard gravity acceleration as a reference.

6. A plant cultivation device having a growing space for cultivating a plant comprising:
a grasper for grasping a tide-generating force; and
a growth conditions controller for controlling a plant growth conditions in the growing space according to the variation in the tide-generating force.

7. The plant cultivation device according to claim 6,
wherein the plant growth conditions include lighting condition.

8. The plant cultivation device according to claim 6,
wherein the tide-generating force grasper comprises a relative gravity acceleration calculator, and
wherein the growth conditions controller comprises a controller for controlling a plant growth conditions in the growing space according to the calculated relative gravity acceleration.

9. The plant cultivation device according to claim 8,
wherein a plant is grown under dark condition in a time period when the relative gravity acceleration changes from plus to minus based on the standard gravity acceleration as a reference.

10. The plant cultivation device according to claim 8,
wherein a plant is grown under dark condition in a time period when the relative gravity acceleration changes from minus to plus based on the standard gravity acceleration as a reference.

11. The plant cultivation method according to claim 2,
wherein relative gravity acceleration is used as an index of the tide-generating force.

12. The plant cultivation method according to claim 11,
wherein a plant is grown under dark condition in a time period when the relative gravity acceleration changes from plus to minus based on the standard gravity acceleration as a reference.

13. The plant cultivation method according to claim 11,
wherein a plant is grown under dark condition in a time period when the relative gravity acceleration changes from minus to plus based on the standard gravity acceleration as a reference.

14. The plant cultivation device according to claim 7,
wherein the tide-generating force grasper comprises a relative gravity acceleration calculator, and
wherein the growth conditions controller comprises a controller for controlling a plant growth conditions in the growing space according to the calculated relative gravity acceleration.

15. The plant cultivation device according to claim 14,
wherein a plant is grown under dark condition in a time period when the relative gravity acceleration changes from plus to minus based on the standard gravity acceleration as a reference.

16. The plant cultivation device according to claim 14,
wherein a plant is grown under dark condition in a time period when the relative gravity acceleration changes from minus to plus based on the standard gravity acceleration as a reference.
